(19) United States
(12) Patent Application Publication
(10) Pub. No.: US 2007/0042191 A1
(43) Pub. Date: Feb. 22, 2007

(54) Tougher cycloaliphatic epoxide resins

(76) Inventors: James Wells Carter, Lake Jackson, TX (US); Jessica Ann Cook, Houston, TX (US); Keith T. Lamb, Springfield, NJ (US); Harshad M. Shah, Stafford, TX (US)

Correspondence Address: UNION CARBIDE CHEMICALS AND PLASTICS TECHNOLOGY;CORPORATION, P.O. BOX 1967, MIDLAND, MI, 48641-1967, US

(21) Appl. No.: 10/575,286

(22) PCT Filed: Sep. 10, 2004
(86) PCT No.: PCT/US04/29996

§ 371 Date: Apr. 26, 2006

Related U.S. Application Data
(60) Provisional application No. 60/516,878, filed on Nov. 3, 2003.

(51) Int. Cl. B32B 27/38; C08G 59/20

(52) U.S. Cl. 428/413; 528/418

(57) ABSTRACT

A method for enhancing the toughness, e.g., resistance to cracking upon flexing, of coatings made from cycloaliphatic epoxy resins wherein the cycloaliphatic epoxy resin is a cycloaliphatic epoxide ester of a hydroxy-functional compound containing at least one cycloaliphatic ring.

This application claims the benefit of U.S. Provisional application Ser. No. 60/516,878, filed Nov. 3, 2003.

### BACKGROUND OF THE INVENTION

The present invention generally relates to epoxide-containing compounds and methods for enhancing the toughness of coatings made from such compounds. More specifically, the present invention relates to the use of cycloaliphatic epoxy resins of certain hydroxy-functional compounds as coating materials that can have enhanced toughness.

Toughness may be viewed as improved flexibility while keeping the hardness essentially constant, or as improved hardness while keeping the flexibility essentially constant, or as improving both the flexibility and hardness simultaneously. Improved flexibility typically results in a softer cured composition, while improved hardness typically results in a more brittle, or less flexible, cured composition. Toughness may also be viewed as improved resistance to cracking during thermal cycling.

Cationic UV-curable epoxy compositions contain an epoxy resin and a cationic photoinitiator that releases an acid when exposed to UV and, optionally, a polyol, oxetane compound, vinyl ether compound, and/or acrylate compound. Cationic UV-curable coatings are commonly applied to steel and aluminum sheets and coils used for manufacturing can ends, drawn can bodies including shallow drawn cans, aerosol cans, crowns, closures, and other steel and aluminum containers. The steel sheets and coils may be tin-free steel or tin-plated steel. The steel and aluminum sheets and coils may be primed or not primed, sized or not sized, and printed with inks or not printed with inks. Cationic UV-curable coatings frequently are applied to steel and aluminum sheets and coils used in applications involving hot water and steam sterilization, such as retort and pasteurization, and these applications include food and beverage can bodies, can ends, crowns, and closures. Retort is generally conducted using an autoclave at temperatures above the boiling point of water and under pressure and is used to kill bacteria in canned food, including some canned beverages. Pasteurization involves hot water immersion or spray and is used to kill bacteria in canned beverages such as beer.

Current cationic UV-curable coatings used to protect steel can ends may crack during fabrication of the end and attachment of the end to the can body by a process known as double seaming. The coating may crack during retort and/or during transportation. Current cationic UV-curable coatings used to protect crowns and closures may crack when the crown or closure is fabricated, transferred using a hopper, or during retort and pasteurization. Cracks in the coating allow water to contact the steel causing the steel to discolor. Discoloration of the steel makes the container unattractive to the customer.

Anhydride-cured epoxy compositions typically contain an epoxy resin, such as a cycloaliphatic epoxy, an anhydride, and optionally a polyol, catalyst, and anti-oxidant. Anhydride-cured epoxy compositions are used to encapsulate and insulate a variety of electrical and electronic parts such as light-emitting diodes and fly back transformers. Current anhydride-cured compositions containing cycloaliphatic epoxides tend to be hard but brittle. The brittle nature can be demonstrated by encapsulating a steel washer and subjecting the encapsulation to thermal cycling. A brittle composition will crack upon thermal cycling.

In view of the problems facing the industry, there is a clear need for tougher epoxy compositions.

### SUMMARY OF THE INVENTION

The present invention includes a method of enhancing the toughness of a coating on an article, said coating comprising a cured cycloaliphatic epoxy resin, said method comprising using as the epoxy resin a compound of the formula: 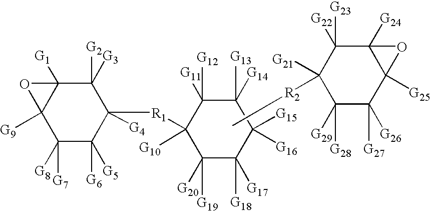
wherein R₁ and R₂ are divalent organic moieties that may be the same or different. The invention also includes curable compositions including the resin described above and an appropriate catalyst or initiator.

The compositions of the invention impart surprisingly improved toughness to coatings and other end products prepared therefrom, and are useful in applications including UV-curable coatings, thermally-curable coatings, and LED encapsulants.

### DETAILED DESCRIPTION OF THE INVENTION

The curable formulations of the invention include UV-curable formulations and heat-curable formulations. The UV-curable formulations include a cycloaliphatic epoxy resin and a cationic photoinitiator. The heat-curable formulations include a cycloaliphatic epoxy resin and a cationic thermal catalyst. The cycloaliphatic epoxy resin of the invention can be prepared via several routes; however, the preferred route for preparing the cycloaliphatic epoxy resin of the invention involves contacting a cycloaliphatic epoxide and a hydroxy-functional compound under reaction conditions such that the cycloaliphatic epoxy resin of the invention is formed.

The cycloaliphatic epoxide starting materials suitable for use in accordance with the present invention can be any cycloaliphatic epoxides that also have at least one functional group, e.g., acid, alcohol or, preferably, ester, which can react with the hydroxyl groups of a hydroxy-functional compound containing one or more units. Advantageously, the cycloaliphatic epoxides have from about 5 to about 7 carbon atoms, preferably 6 carbon atoms, in the ring. The cycloaliphatic epoxides can have one or more epoxide groups, preferably one, per ring. In addition, the cycloaliphatic epoxides can comprise one or more rings, e.g., up to about 3, can be saturated or unsaturated, and can have other substituents on the rings, such as hydrocarbon moieties.

Preferably, the cycloaliphatic epoxide starting material has the following structure: wherein R₆ is hydrogen or an organic moiety, preferably hydrogen or a hydrocarbon radical having from 1 to about 30 carbon atoms, and more preferably a linear or branched alkyl moiety having from 1 to about 10 carbon atoms, and G₁ to G₉ are independently hydrogen, phenyl or substituted or unsubstituted alkyl or alkene moieties having from 1 to about 10 carbon atoms.

Illustrative of the cycloaliphatic epoxides useful as starting materials in the present invention are methyl 3,4-epoxycyclohexane-carboxylate, ethyl 3,4-epoxycyclohexanecarboxylate, propyl 3,4-epoxycyclohexanecarboxylate, isopropyl 3,4-epoxycyclohexanecarboxylate; n-butyl-, 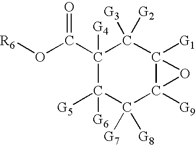
i-butyl-, s-butyl-, and t-butyl 3,4-epoxycyclohexanecarboxylate; the various amyl and hexyl 3,4-epoxycyclohexanecarboxylates; methyl 3,4-epoxy-3-methyl-cyclohexanecarboxylate; ethyl 3,4-epoxy-3-methyl-cyclohexanecarboxylate; methyl 3,4-epoxy-4-methyl-cyclohexanecarboxylate; ethyl 3,4-epoxy-4-methyl-cyclohexane-carboxylate; butyl 3,4-epoxy-3-methyl-cyclohexanecarboxylate; butyl 3,4-epoxy-4-methyl-cyclohexanecarboxylate; methyl 3,4-epoxy-6-methyl-cyclohexanecarboxylate; ethyl 3,4-epoxy-6-methyl-cyclohexane-carboxylate; butyl 3,4-epoxy-6-methyl-cyclohexanecarboxylate; dialkyl 4,5-epoxycyclo-hexane-1,2-dicarboxylates, as well as mixed dialkyl 4,5-epoxycyclo-hexane-1,2-dicarboxylates, and the like. Mixtures of cycloaliphatic epoxides can be employed.

The hydroxy-functional compounds suitable for use as starting materials in accordance with the present invention contain at least one cycloalkane unit. Advantageously, the cycloalkane unit comprises from about 4 to about 8 carbon atoms and preferably from about 4 to about 6 carbon atoms and at least about 2 hydroxyl moieties. More preferably, the cycloalkane unit is a cyclohexane unit. The hydroxyl-functional compounds can have one or more cycloalkane units per molecule. Preferably, the hydroxy-functional compound contains one cycloalkane unit.

In a preferred aspect of the present invention, the hydroxy-functional compounds suitable for use as a starting material have the formula: 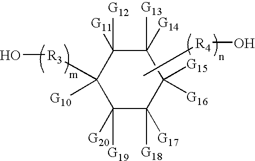
wherein R₃ and R₄ are organic moieties capable of bonding with oxygen, G₁₀ through G₂₀ are hydrogen, phenyl or substituted or unsubstituted alkyl or alkene groups having from 1 to about 10 carbon atoms, m and n have values from 0 to about 30, and the relative positions of R₃ and R₄ on the cyclohexane ring are 1, 2 or 1, 3 or 1,4. In a preferred aspect of the invention, R₃ and R₄ are methylene units (that is, —CH₂—), G₁₀ through G₂₀ are hydrogen, and the relative positions of R₃ and R₄ on the cyclohexane ring are 1, 3 or 1,4 or mixtures containing 1,3 and 1,4. Mixture of hydroxy-functional compounds can be employed.

In general, suitable hydroxy-functional compounds for use in accordance with the present invention include alcohols, glycols, polyols, and polymeric compounds containing at least one cycloalkane unit. Some specific examples of hydroxy-functional compounds suitable for use in accordance with the present invention include, but are not limited to 1,2-cyclohexanedimethanol, trans-1,2-cyclohexanedimethanol, 1,3-cyclohexanedimethanol, 1,4-cyclohexanedimethanol, 1,2-cyclohexanediol, 1,3-cyclohexanediol, 1,4-cyclohexanediol, and mixtures thereof.

Many hydroxy-functional, including acid-functional and ester-functional, compounds such as described above are commercially available. Those skilled in the art are familiar with synthetic chemistry techniques that can be used to prepare such hydroxy-functional compounds.

Advantageously, the cycloaliphatic epoxy resins of the present invention comprise the reaction products of from about 10 to about 95, preferably from about 20 to about 90 and more preferably from about 40 to about 90 weight percent of the cycloaliphatic epoxide and typically from about 5 to about 90, preferably from about 10 to about 80 and more preferably from about 10 to about 60-weight percent of the hydroxy-functional compound based upon the total weight of the cycloaliphatic epoxy resins (cycloaliphatic epoxide plus hydroxy-functional compound).

The particular process used for manufacturing the cycloaliphatic epoxy resins of the present invention is not critical. Suitable processes include transesterification such as disclosed in European Patent Application Publication 0 479 166 A1, and epoxidation such as disclosed, for example, in U.S. Pat. No. 5,268,489, the teachings of which are incorporated herein by reference.

When the cycloaliphatic epoxy resins of the present invention are prepared by transesterification, a cycloaliphatic epoxide ester, e.g., an alkyl 3,4 epoxycyclohexanecarboxylate, is combined with a hydroxy-functional compound and an optional catalyst. The mixture is then stirred in bulk or in dilution with an optional solvent and heated for an amount of time effective to react the desired amount of the cycloaliphatic epoxide ester onto the hydroxy-functional compound. In general, it is advantageous to remove any by-products, like alcohols, by distillation or sparging with a dry gas such as argon or nitrogen. A solvent that forms an azeotrope with the by-product can optionally be used to facilitate its removal. The reaction can be carried to completion or only partial completion to provide a mixture of epoxy-functional compounds.

The starting mole ratio of epoxide groups to hydroxyl groups can be any desired ratio. If it is desired to obtain a substantially complete conversion to a product with a high amount of epoxy substituents, the starting epoxide to hydroxyl mole ratio should be greater than 1, preferably from greater than about 1 to about 3 and most preferably from about 1.1 to about 2. When an excess of the cycloaliphatic epoxide starting material is used, the excess, if any, can be easily removed upon completion of the reaction by distillation under vacuum conditions. Alternatively, if a product with a low residual monomer content is desired, it is advantageous to utilize a starting epoxide to hydroxyl mole ratio of less than 1, preferably from about 0.9 to about 0.99 and more preferably from about 0.95 to about 0.98. If a product is desired with only partial epoxide substitution and containing some remaining hydroxy-functionality, then it is advantageous to use a starting epoxide to hydroxyl mole ratio of significantly less than 1, preferably from about 0.2 to about 0.9 and more preferably from about 0.4 to about 0.85. In all cases, but particularly in cases where in the epoxide to hydroxyl mole ratio is significantly less than 1, care must be taken to avoid excessive temperatures and reaction times that can lead to oligomerization of the product, with a corresponding increase in viscosity and reduction in functionality.

The transesterification reaction can be carried out at temperatures effective to conduct the transesterification, e.g., about 50° C. to about 250° C., and preferably at temperatures of about 70° C. to about 200° C. The time for completion of the transesterification reaction will typically range from about 10 minutes to about 40 or more hours depending on the temperature employed and the particular ingredients involved. The preferred time of reaction is from about 1 to about 16 hours. The transesterification can be carried out at atmospheric pressure, subatmospheric pressure, or superatmospheric pressure; however, it is preferred that the reaction be carried out at pressures of about 0.001 atmosphere to about 1.5 atmosphere. The particular process parameters employed will depend on the particular ingredients used, the batch size, and other variables, the details of which are known to those skilled in the art.

A catalyst can be employed to catalyze the transesterification reaction. Catalysts useful for the transesterification reaction are well known to those skilled in the art, and many are readily commercially available. Illustrative of the catalysts useful for the transesterification reaction are: salts of weak acids such as, for example, sodium bicarbonate, potassium bicarbonate, potassium thiocyanate, barium thiocyanate, calcium thiocyanate, cesium thiocyanate, cobalt thiocyanate, lead thiocyanate, lithium thiocyanate, sodium thiocyanate, zinc thiocyanate, sodium acetate, lithium acetate, potassium acetate, cesium acetate, calcium acetate, zinc acetate, sodium propionate, potassium butyrate, calcium isobutyrate, zinc 2-ethylhexanoate, and other metal salts of acetic acid; carbonic acid and carboxylic acids; alkali metal alkoxides such as sodium methoxide, potassium methoxide, lithium methoxide, zinc methoxide, calcium methoxide, cesium methoxide, potassium t-butoxide, potassium n-butoxide, sodium i-propoxide, lithium ethoxide, and potassium cyanide; sodium cyanide; metal oxalates; calcium hydride; cesium fluoride; and the like. Titanium (IV) i-propoxide can also be used. Mixtures of catalysts can be employed when desired. The catalysts are typically employed in amounts of from 0.0001 to 5 mole percent, and preferably from 0.001 to 1 mole percent, based on the total moles of hydroxyl groups in the starting hydroxy-functional compound. Preferred catalysts include sodium acetate and titanium (IV) isopropoxide. The catalyst may be added to the reaction mass all at one time, in discrete portions that may be of the same or different size, or in a continuous uniform or non-uniform manner over the entire reaction time period or over a portion of the reaction time period. For example, with a catalyst like sodium acetate, using about 30 wt. % heptane solvent relative to the total weight of reactants, a suitable reaction temperature is usually from about 100° C. to about 150° C. and preferably from about 110° C. to about 130° C. For a more reactive catalyst like alcoholic sodium methoxide, a suitable reaction temperature can be much lower, usually from about −40° C. to about 100° C., preferably from about −10° C. to about 80° C.

The optional solvent can be left in the reaction mixture or can be removed at the end of the reaction by distillation or by other techniques known to those skilled in the art.

The presence of water is generally not advantageous for the reaction, and pre-drying of the starting materials can optionally be carried out, e.g., by heating the combined reaction components with a water-azeotroping solvent at the solvent's boiling temperature to facilitate water removal before adding the catalyst. Alternatively or in addition, drying can be accomplished by sparging the heated reaction mixture with a dry gas, treating with molecular sieves or by any other method known to those skilled in the art.

When an epoxidation reaction is employed to prepare an epoxy resin, epoxidizing agents of various types can be used. These agents can be formed in situ from hydrogen peroxide and an organic acid such as acetic acid and optionally a catalyst such as sulfuric acid, can be formed in situ from ozone and an aldehyde such as acetaldehyde, can be pre-formed and used as a peracid, or can be in the form of a dioxirane such as dimethyldioxirane, and the like. Illustrative of the peracids that can be used in carrying out epoxidations are perbenzoic acid, peracetic acid, perpropionic acid, percaproic acid, permonochloroacetic acid, meta-chloroperoxybenzoic acid, perbutyric acid, perlactic acid, permonosuccinic acid, t-butylperbenzoic acid, and the like. When used, the peracids are usually dissolved in a solvent such as ethyl acetate to minimize explosive and other hazards.

In the epoxidation reaction, an unsaturated, cycloaliphatic compound, e.g., a 3-cyclohexanecarboxylic acid ester of a di- or multi hydroxy-functional compound, is reacted with the epoxidizing agent at temperatures of from less than about 5° C. to about 90° C., preferably at temperatures of from about 10° C. to about 80° C., and most preferably at temperatures of from about 20° C. to about 70° C. The time required for reaction will vary depending upon the particular reactants charged and the temperature, the details of which are well known to those skilled in the art of epoxidation chemistry. Typical reaction pressures are from about 0.1 atm to about 10 atm. In general, a peracid solution is carefully and very slowly added to the reactor containing the starting materials, in either a neat form or preferably dissolved in a suitable inert solvent such as ethyl acetate, which is held at a relatively constant reaction temperature. The reaction can be optionally carried out in a series of reaction vessels with different set temperatures and configurations. The rate of peracid addition should be such that a desired maximum temperature is not exceeded. The exothermic oxidation reaction that takes place is controlled by cooling the reaction mass to the desired reaction temperature. The peracid addition rate is decreased or stopped if necessary to maintain temperature control. A method of quenching the reaction is usually made available and maintained as, for example, in the laboratory an ice/water bath is available. The reaction product is then optionally washed one or more times with water to remove by-product acid, such as acetic acid when peracetic acid is used, and oxidizing agent. The product is isolated by vacuum stripping of the organic acid that is formed and the solvent. Optionally, the product may be washed one or more times with water. If desired, the product may be redissolved and reisolated by vacuum stripping using conventional techniques, distillation, or other recovery methods. Further details concerning epoxidation are known to those skilled in the art.

In a preferred aspect of the present invention, the cycloaliphatic epoxy resin has the formula: 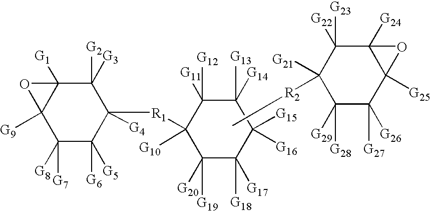
wherein R₁ and R₂ are divalent organic moieties that may be the same or different. The preferred cycloaliphatic epoxy resins contain a cyclohexyl ring in the backbone, which is separated by groups R₁ and R₂ from the epoxycyclohexyl groups. Preferably, R₁ and R₂ are substituted or unsubstituted moieties of from 1 to about 30 carbon atoms. More preferably, R₁ and R₂ are independently alkylene, ester, alkyl ester; ether or alkoxy moieties. Preferably, R₁ and R₂ are the same and are methylene ester. G₁ through G₂₉ are preferably hydrogen or methyl, preferably —H. Note that G₂₁₋₂₉ are derived from G₁₋₉ of a cycloaliphatic epoxide starting material.

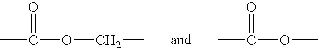

Most preferably, R₁ and R₂ independently are selected from:

Examples of preferred cycloaliphatic epoxy resins that can be employed in the method of the invention include those shown in the following formulas:

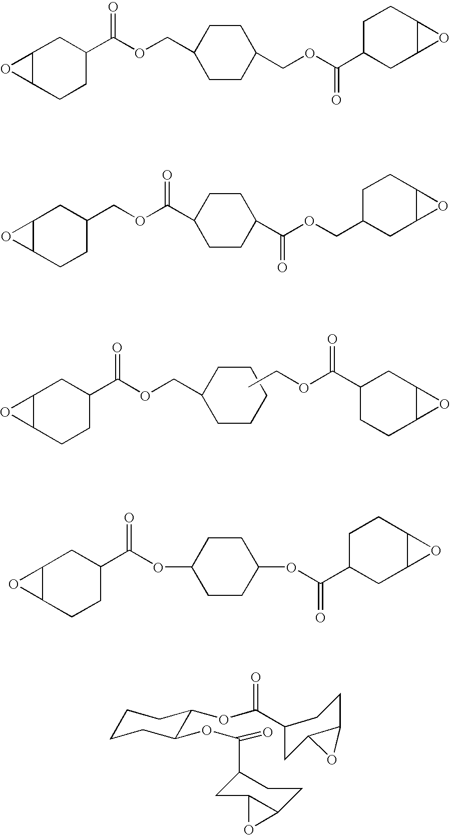

For some applications, it may be desirable to further treat the epoxy resins of the invention to improve color or purity. For example, the epoxy resins of the invention can be treated by water washing and drying to remove catalyst residue.

The cycloaliphatic epoxy resins of the present invention can be used for a broad variety of end uses including, for example, as LED encapsulants, coatings for food and beverage containers, automotive coatings, general metal coatings, decorative coatings, electronics coatings including, for example, protective coatings for compact and optical discs, and the like, as well as inks, molded objects, sealants and adhesives used in the automotive, home and electronic industries.

The coatings can be applied by various known techniques, illustrative of which are spray coating, roll coating, dip coating, brush, and the like. The coatings can be cured by a variety of known techniques, including radiation, thermal, air drying, and the like, depending on the particular system being formulated.

Cationic UV-curable coating compositions containing the cycloaliphatic epoxy resins of the invention have improved toughness, i.e. have improved flexibility and high hardness. The improved flexibility is especially apparent when coated steel samples are bent and retorted. Anhydride-cured compositions containing the preferred cycloaliphatic epoxy resins have improved toughness as exhibited by the fact that they have improved resistance to cracking when an encapsulated steel washer is thermally cycled.

The cycloaliphatic epoxy resins of the present invention can be advantageously used in a method to enhance the toughness, e.g., resistance to cracking upon flexation, of a coating on an article. As a result, coatings made from the cycloaliphatic epoxy resins of the present invention can be particularly useful when applied to substrates prior to forming the substrates into the desired shapes to form the article. This formation technique is common in the manufacture of beer and beverage containers, food containers, and other rigid containers. In addition, coatings made from the cycloaliphatic epoxy resins of the present invention can have a high degree of hydrolytic stability that renders them suitable for applications that undergo retort treatment, e.g., to sanitize the articles.

In producing coatings curable with actinic radiation, preferably ultraviolet light, the cycloaliphatic epoxy resins are often combined with other cycloaliphatic epoxides, Novolac epoxides, and the like; vinyl ethers; acrylates and methacrylates; polyols; onium salt, diazonium salt or other cationic photoinitiators; and, if desired, surfactants; oils; fillers and other additives known to those skilled in the art. The formulated coatings may contain inert solvents or reactive diluents for the purpose of decreasing viscosity and improving application characteristics or inert polymers, fumed silicas, and the like, to thicken the formulated coating and make it useful in screen printing or other operations. The coatings are typically cured by exposure to ultraviolet light wavelengths from a medium pressure mercury vapor lamp with radiation between about 220 and 400 nanometers. Further details concerning the selection and amounts of such additional materials are known to those skilled in the art. See, for example, U.S. Pat. No. 5,268,489, the teachings of which are incorporated herein by reference. The photocurable compositions typically contain, exclusive of photoinitiator, from about 25% to 100% of the cycloaliphatic epoxy resins, from 0% to about 60% of other hydroxyl-containing compounds, from 0% to about 75% of other cycloaliphatic or other epoxide, from 0% to about 60% vinyl ether, and from 0% to about 60% acrylate.

The thermally-curable compositions can contain suitable catalysts such as, for example, sulfuric acid, hydrochloric acid, p-toluene sulfonic acid, methyl sulfonic acid, phosphoric acid and alkyl derivatives of phosphoric acid, maleic acid, trimellitic acid, triflic acid, salts of triflic acid such as the diethylammonium salt of triflic acid, the ammonium salt of triflic acid, the stannous salt of triflic acid, stannous octanoate, uranyl nitrate, zinc octanoate, and the like, including mixtures of these catalysts. The thermally-curable compositions typically contain, exclusive of catalyst, from about 25% to 100% of the cycloaliphatic epoxy resins, from 0% to about 60% of other hydroxyl-containing compounds, and from 0% to about 75% of other cycloaliphatic or other epoxides. The thermally-curable compositions may also contain other ingredients such as one or more surfactants, flow and leveling agents, fumed silicas, silicone oils and other slip agents, and other ingredients suitable for coatings known to those skilled in the art. Thermal curing is typically conducted by heating at a suitable temperature generally from about 50° C. to about 275° C., preferably from about 90° C. to about 200° C., for a period of time sufficient to obtain a dry film. Generally this time will range from about one minute to about two hours.

### SPECIFIC EMBODIMENTS OF THE INVENTION

The following examples and comparative experiments are given to illustrate the invention, but are not to be construed as limiting its scope. All parts and percentages are by weight unless otherwise indicated.
Starting Materials: 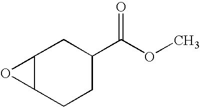
methyl-3,4-epoxycyclohexane carboxylate (MEC)

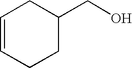

3-Cyclohexene-1-methanol
(THBOH)

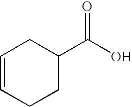

3-Cyclohexene

carboxylic acid 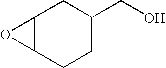
3,4-epoxycyclohexane-1-methanol

(THBOH epoxide)

The preparation of Resin A and Resin C by transesterifying MEC with, for Resin A, 1,4-cyclohexanedimethanol, and with, for Resin C, a mixture containing 1,3- and 1,4-cyclohexanedimethanol isomers, is described in Examples 1 and 2, respectively.

### EXAMPLE 1

### Preparation of Resin A: bis(3,4-epoxycyclohexanecarboxylic ester) of 1,4-cyclohexanedimethanol

2163.5 g (13.87 equivalents) of MEC, 1000 g (13.87 equivalents) of 1,4-cyclohexanedimethanol (1,4-CHDM), and 1.2654 g of sodium acetate (400 ppm) are weighed into a glass reaction flask (reactor). The reactor is equipped with a condenser and a trap, a mechanical stirrer, and an opening for a nitrogen sparge. Dry nitrogen gas is sparged into the reactor contents at a rate of 3 liters per minute and the contents are stirred continuously during the reaction using a mechanical stirrer. The reactor contents are heated to 130° C. and held at this temperature for 3.5 hours while the methanol by-product from the transesterification reaction is collected in a trap. The product of the reaction is designated Resin A.

Resin A contains 4.6% of material having a GPC retention time of 12.9 minutes believed to be epoxide oligomers, 91.5% of material having a GPC retention time of about 12.8 minutes believed to be the diepoxide and mono-epoxide of 1,4-CHDM, and 3.9% of material having a GPC retention time of 17.4 minutes believed to be MEC. The experimental and theoretical epoxide equivalent weight values of the resin are, respectively, 206 and 196.1 g/epoxide equivalent. The experimental epoxide equivalent weight value of the resin is 5.3% higher than its theoretical value. The resin crystallizes after cooling to room temperature.

### EXAMPLE 2

### Preparation of Resin C: bis(3,4-epoxycyclohexanecarboxylic ester) of 1,4-cyclohexanedimethanol Liquid

The method of Example 1 is repeated, except that a mixture containing 1,3-CHDM and 1,4-CHDM isomers is employed instead of 1,4-CHDM. The product epoxy resin, Resin C, is a liquid at room temperature and it does not appear to form crystals.

Resin C contains 2.8% of material having a GPC retention time of 13.6 minutes, believed to be epoxide oligomers, 92.8% of material having a GPC retention time of 15.3 minutes, believed to be the diepoxide and mono-epoxide of 1,3- and 1,4-CHDM isomers, 1.7% of material having a GPC retention time of 17.3 minutes, believed to be 1,3- and 1,4-CHDM isomers, and 3.2% of material having a GPC retention time of 18.2 minutes believed to be MEC. The experimental and theoretical epoxide equivalent weight values of the resin are, respectively, 207 and 196.1 g/epoxide equivalent. The experimental epoxide equivalent weight value of the resin is 5.7% higher than its theoretical value. The Brookfield viscosity (model DV-1+, # 3 spindle at 20 rpm) after the sample is equilibrated in a water bath at 25° C. of the resin is 2,000 cps.

### EXAMPLE 3

### Preparation of Distilled Resin A

This example describes the distillation of Resin A. Distilled Resin A is another example of an epoxy resin of the invention.

Resin A is prepared as described in Example 1 and is distilled using two passes through a thin film evaporator. An oil circulation bath temperature of 235° C., a vacuum of 1.0 mm Hg, and a feed rate of 300 grams per hour (without a cold finger) are used during the first pass through the thin film evaporator.

About 85% of a yellow product is obtained from the first pass. The epoxy resin contains 2.8% of material having a GPC retention time of 13.1 to 13.4 minutes, believed to be epoxide oligomers, and 96.61% of material having a GPC retention time of 14.5 minutes, believed to be the diepoxide and mono-epoxide of 1,4-CHDM.

An oil circulation bath temperature of 255° C., a vacuum of <1.0 mm Hg, a cold finger using water circulation having a temperature of 10° C., and a feed rate of 100 to 150 grams per hour are used during the second pass through the thin film evaporator.

About 50% of a colorless product is obtained from the distillation. Distilled Resin A contains 0.5% of material having a GPC retention time of 12.9 to 13.1 minutes, believed to be epoxide oligomers, 97.2% of material having a GPC retention time of 14.0 minutes believed to be the diepoxide and mono-epoxide of 1,4-CHDM, and 2.3% of material having a GPC retention time of 15.1 to 16.3 minutes, believed to be low molecular weight compounds formed during distillation. The experimental and theoretical epoxide equivalent weight values of the resin are, respectively, 221 and 196.1 g/epoxide equivalent. The experimental epoxide equivalent weight value of the resin is 12.7% higher than its theoretical value.

### EXAMPLE 4

### Preparation of Resin A-Ti: bis(3,4-epoxycyclohexanecarboxylic ester) of 1,4-cyclohexanedimethanol using titanium (IV) isopropoxide catalyst

375.0 grams (2.4 equivalents) of MEC and 190.36 grams (1.32 equivalents) of 1,4-CHDM are weighed into a three-neck glass reaction flask (reactor). The reactor is equipped with a short-path condenser and a trap, a magnetic stirring bar, and an opening for nitrogen sparge. Dry nitrogen gas is sparged into the reactor contents at a rate of 2 liters per minute and the contents are stirred using a magnetic stirring bar continuously during the reaction. The reactor contents are heated to 150° C. and 2.05 grams (0.0072 equivalents) (3600 ppm) of titanium (IV) isopropoxide catalyst is charged using a pressure-lock syringe. The reactor is held at 150° C. for 3 hours while the methanol by-product from the transesterification reaction is collected in the trap. The product of the reaction is an epoxy resin, designated Resin A-Ti.

Resin A-Ti contains 12% of material having a GPC retention time of 12.6 to 13.4 minutes, believed to be epoxide oligomers, 86.5% of material having a GPC retention time of 15 minutes, believed to be the diepoxide and mono-epoxide of 1,4-CHDM, and 0.7% of material having a GPC retention time of 17.4 minutes believed to be MEC.

The experimental and theoretical epoxide equivalent weight values of the resin are, respectively, 218.2 and 196.1 glepoxide equivalent. The experimental epoxide equivalent weight value of the resin is 11.3% higher than its theoretical value.

### EXAMPLE 5

### Preparation of Resin E: bis(3,4-epoxycyclohexanecarboxylic ester) of trans-1,2-cyclohexanediol

122.5 grams (0.784 equivalents) of MEC, 50.1 grams (0.4312 equivalents) of trans-1,2-cyclohexanediol, and 0.0643 grams (0.000784 equivalents) of sodium acetate (372 ppm) are weighed into a three-neck glass reaction flask (reactor). The reactor is equipped with a short-path condenser and a trap, a magnetic stirring bar, and an opening for nitrogen sparge. Dry nitrogen gas is sparged into the reactor contents at a rate of 1 liter per minute and the contents are stirred using a magnetic stirring bar continuously during the reaction. The reactor contents are heated to 130° C. and held at this temperature for 3 hours while the methanol by-product from the transesterification reaction is collected in the trap. The product of the reaction is an epoxy resin, designated Resin E.

Resin E contains 18.1% of material having a GPC retention time of 12.6 to 13.4 minutes believed to be epoxide oligomers, 86.5% of material having a GPC retention time of 15 minutes believed to be the diepoxide and mono-epoxide of trans-1,2-cyclohexanediol, and 0.7% of material having a GPC retention time of 17.4 minutes believed to be MEC.

The experimental and theoretical epoxide equivalent weight values of the resin are, respectively, 202.7 and 196.1 g/epoxide equivalent. The experimental epoxide equivalent weight value of the resin is 3.3% higher than its theoretical value.

### EXAMPLE 6

### Preparation of Resin D: bis(3,4-epoxycyclohexanecarboxylic ester) of 1,4-cyclohexanediol

250 grams (1.6 equivalents) of MEC, 102.22 grams (0.88 equivalents) of 1,4-cyclohexanediol, and 0.1313 grams (0.0016 equivalents) of sodium acetate (373 ppm) are weighed into a three-neck glass reaction flask (reactor). The reactor is equipped with a short-path condenser and a trap, a magnetic stirring bar, and an opening for nitrogen sparge. Dry nitrogen gas is sparged into the reactor contents at a rate of 2 liter per minute and the contents are stirred using a magnetic stirring bar continuously during the reaction. The reactor contents are heated to 130° C. and held at this temperature for 3 hours while the methanol by-product from the transesterification reaction is collected in a trap. The product of the reaction is an epoxy resin, designated as Resin D.

Resin D contains 7.35% of material having a GPC retention time of 13.6 to 14.4 minutes believed to be epoxide oligomers, 89.1% of material having a GPC retention time of 15.36 minutes believed to be the diepoxide and mono-epoxide of 1,4-cyclohexanediol, and 1.84% of material having a GPC retention time of 17.4 minutes believed to be MEC.

The experimental and theoretical epoxide equivalent weight values of the resin are, respectively, 201.4 and 196.1 g/epoxide equivalent. The experimental epoxide equivalent weight value of the resin is 2.7% higher than its theoretical value.

### EXAMPLE 7

### Preparation of Resin B: bis[(3,4-epoxycyclohexyl)methyl]1,4-cyclohexanedicarboxylate using methyl 1,4-cyclohexanedicarboxylate

169.2-g (1.54 equivalents) THBOH, 150-g (1.50 equivalents) methyl 1,4-cyclohexanedicarboxylate, and 0.4788-g para-toluene sulfonic acid (PTSA) are weighed into a three-neck glass reaction flask (reactor). Dry nitrogen gas is sparged into the reactor contents at a rate of about 0.2-liters per minute. The reactor contents are heated to 165° C. and held at this temperature for a total of about 57 hours while the methanol by-product from the transesterification reaction is collected in a trap. The reaction product is purified by distillation. The product contains a mixture of diene and mono-ene identified using carbon-13 NMR spectroscopy. The product is epoxidized using peracetic acid to yield an epoxy resin. The epoxy resin, Resin B, contains a mixture of diepoxides and mono-epoxides.

### EXAMPLE 8

### Preparation of Resin B-1 using 1,4-cyclohexanedicarboxylic acid

294.3-g (2.67 equivalents) THBOH, 200-g (2.32 equivalents) 1,4-cyclohexanedicarboxylic acid, and 0.1780-g stannous oxalate are weighed into a glass reaction flask (reactor). The reactor is equipped with a condenser and a trap, a mechanical stirrer, and an opening for nitrogen sparge. Dry nitrogen gas is sparged into the reactor contents at a rate of about 0.38-liters per minute and the contents are stirred using a mechanical stirrer continuously during the reaction. The reactor contents are heated to 180° C. and held at this temperature for a total of 6 hours while the water by-product from the esterification reaction is collected in a trap. The reaction product is purified by distillation and then epoxidized using peracetic acid to give an epoxy resin, Resin B-1. GC analysis finds that the epoxy resin contains about 95.8% diepoxide and 5.1% monoepoxide. Liquid chromatography analysis finds that the epoxy resin contains 92.3% epoxides and 7.1% oligomers.

### COMPARATIVE EPOXY RESIN EXAMPLES

The major component compounds of epoxy resins prepared by transesterifying MEC and polyols as described in Comparative Examples 9-11 are shown below and designated as Resin F, Resin G, and Resin H. Other epoxy resins prepared by transesterfying MEC and other polyols in a similar manner are described in Table 1.

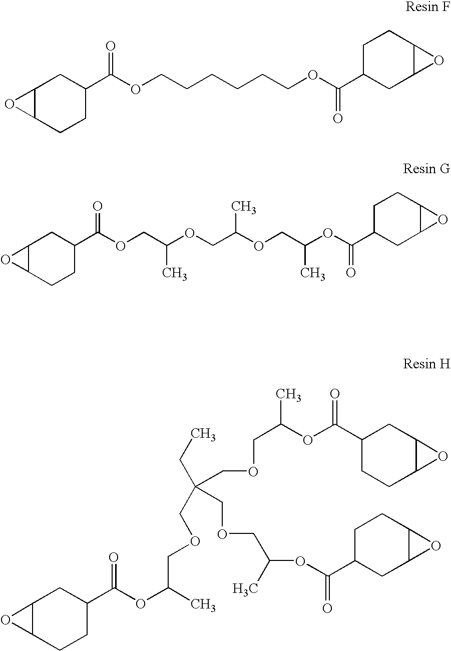

### Comparative Example 9

### (Not an Embodiment of the Invention)—Preparation of Resin F: bis(3,4-epoxycyclohexanecarboxylic ester) of 1,6-hexanediol

390.0-g (2.50 equivalents) MEC, 147.5-g (2.50 equivalents) 1,6-hexanediol, and 0.22-g sodium acetate (409 ppm) are weighed into a glass reaction flask (reactor). The reactor is equipped with a condenser and a trap, a mechanical stirrer, and an opening for nitrogen sparge. Dry nitrogen gas is sparged into the reactor contents at a rate of 2.1 liters per minute and the contents are stirred using a mechanical stirrer continuously during the reaction. The reactor contents are heated to 130° C. and held at this temperature for 3.0 hours while the methanol by-product from the transesterification reaction is collected in a trap. After the reaction, the contents are poured into a glass container and allowed to cool to room temperature.

The resin contains 5.4% of material having a GPC retention time of 13.9 minutes believed to be epoxide oligomers, 92.4% of material having a GPC retention time of 15.25 minutes believed to be the di-epoxide and mono-epoxide of 1,6-hexanediol, and 0.93% of material having a GPC retention time of 17.4 minutes believed to be MEC. The experimental and theoretical epoxide equivalent weight values of the resin are, respectively, 191 and 183.1 g/epoxide equivalent. The experimental epoxide equivalent weight value of the resin is 4.4% higher than its theoretical value. The Brookfield viscosity (model DV-1+, # 3 spindle at 20 rpm) of the resin after the sample is equilibrated in a water bath at 25° C. is 225 cps.

### Comparative Example 10

### (Not an Embodiment of the Invention)—Preparation of Resin G: bis(3,4-epoxycyclohexanecarboxylic ester) of tripropylene glycol

The procedure of Comparative Example 9 is repeated except that 1460.5-g (9.36 equivalents) MEC, 990-g (10.30 equivalents) tripropylene glycol, and 0.98-g sodium acetate (400 ppm) are employed as the starting materials, and the hold time is 3.5 hours.

The resin contains 23.4% of material having a GPC retention time of 12.9 minutes believed to be epoxide oligomers, 70.7% of material having a GPC retention time of 14.3 minutes believed to be the di-epoxide and mono-epoxide of tripropylene glycol, and 4.4% of material having a GPC retention time of 17.2 minutes believed to be MEC. The resin contains 57.6% of material having a GC retention time of 22.5 minutes believed to be the diepoxide of tripropylene glycol, 30.6% of material having a GC retention time of 17.9 minutes believed to be the mono-epoxide of tripropylene glycol, 5% of material having a GC retention time of 11.9 minutes believed to be tripropylene glycol, and 6.9% of material having a two GC signals at 10.8 and 11.1 minutes believed to be MEC. The experimental and theoretical epoxide equivalent weight values of the resin are, respectively, 263 and 220.1 g/epoxide equivalent. The experimental epoxide equivalent weight value of the resin is 19.4% higher than its theoretical value. The Brookfield viscosity (model DV-1+, # 3 spindle at 20 rpm) of the resin after the sample is equilibrated in a water bath at 25° C. is 450 cps.

### Comparative Example 11

### (Not an Embodiment of the Invention)—Preparation of Resin H: bis(3,4-epoxycyclohexanecarboxylic ester) of propoxylated trimethylolpropane

Propoxylated trimethylol propane is washed using aqueous sodium bicarbonate solution. The organic phase is then dried.

The procedure of Comparative Example 9 is repeated except that 436.4-g (2.80 equivalents) MEC, 305-g (1.98 equivalents) of the washed and dried propoxylated trimethylol propane, and 0.30-g sodium acetate (405 ppm) are employed as the starting materials, the nitrogen sparge rate is 2 liters per minute, and the hold time is 3.75 hours.

The resin contains 7% of material having a GPC retention time of 12.5 minutes believed to be epoxide oligomers, 92.1% of material having a GPC retention time of 14.3 minutes believed to be epoxides of propoxylated trimethylol propane, and 0.89% of material having a GPC retention time of 17.5 minutes believed to be MEC. The experimental and theoretical epoxide equivalent weight values of the resin are, respectively, 256 and 226.6 g/epoxide equivalent. The experimental epoxide equivalent weight value of the resin is 12.8% higher than its theoretical value. The Brookfield viscosity (model DV-1+, # 5 spindle at 20 rpm) of the resin after the sample is equilibrated in a water bath at 25° C. is 10,700 cps.

TABLE 1
Comparative epoxy resins prepared by transesterifying
comparative polyols and MEC

| Epoxy resin | | |
|---|---|---|
| description | Respective polyols used to transesterify MEC | EEW* |
| Resin I | Ethylene glycol | 163 |
| Resin J | 1,3-Propanediol | 167 |
| Resin K | 1,4-Butanediol | 175 |
| Resin L | 1,5-Pentanediol | 202 |
| Resin M | 1,8-Octanediol | 205 |
| Resin N | 1,10-Decanediol | 221 |
| Resin O | Ethoxylated trimethylolpropane | 368 |
| Resin P | TONE ™ 0305 polyol, which is a | 349 |
| | caprolactone triol from | |
| | The Dow Chemical Company | |
| | having Mn 540 | |
| Resin Q | Poly(butylene glycol carbonate)diol | 1962 |
| Resin R | Terathane 1000, which is a | 691 |
| | poly(butylene glycol) from | |
| | DuPont having Mn 1000 | |
| Resin S | Priopol 2033, which is a fatty diol dimer from | 475 |
| | Unichema | |

*Epoxy Equivalent Weight

Commercially available comparative epoxy resins are described in Table 2.

TABLE 2
Description of commercially available comparative epoxy resins

| Materials | Description | eq. wt.. |
|---|---|---|
| UVR-6110 | Comparative cycloaliphatic epoxy resin from | 136 |
| | The Dow Chemical Company | |
| D.E.R. 331 | Comparative liquid bisphenol-A epoxy resin from | 186 |
| | The Dow Chemical Company | |
| UVR-6128 | Comparative cycloaliphatic epoxy resin from | 201 |
| | The Dow Chemical Company | |

Preparation of Curable Compositions

Cycloaliphatic epoxy resins of the invention described in Examples 1-8 are used to prepare UV coating compositions of the invention. Comparative epoxy resins described in Examples 9-11 and in Tables 1 and 2 are used to prepare comparative UV coating compositions. Other coating ingredients are described in Table 3.

TABLE 3
Description of other materials used to prepare epoxy compositions

| Materials | Description |
|---|---|
| TONE 0301 | Caprolactone triol Mn about 300 from |
| | The Dow Chemical Company |
| 1,4-CHDM | 1,4-Cyclohexanedimethanol from Eastman |
| UVI-6692 | Mixed sulfonium salt photoinitiator solution from |
| | The Dow Chemical Company |
| DC-57 | Silicone surfactant from Dow-Corning Corporation |
| L-7604 | Silicone surfactant from Crompton |
| 4221D | (Comparative) distilled cycloaliphatic epoxy resin from |
| | The Dow Chemical Company |
| MHHPA | 4-methylhexahydrophthalic anhydride from Lonza |
| DABCO | 1,4-diazabicyclo[2.2.2]octane from Aldrich |

Curing and Testing of the Compositions

UV coatings are cured using a conveyorized UV unit supplied by Fusion UV Systems, Inc. The UV bulb used is a 300 W/in mercury UV bulb.

Tin-free steel (TFS) used to make food can ends is obtained from Weirton Steel and cut into panels. The UV coating formulations are applied onto TFS panels at a thickness of 4 to 5 micrometers using a number 2.5 wire-wound rod. The coatings are UV cured using an energy density of 150 mJ/cm² obtained by using a conveyor speed of 100 feet per minute (fpm).

In a can end manufacturing operation that uses UV curing, the UV curable coating typically is applied first to TFS or tin-plate sheets and the coated sheets are passed through a conveyorized UV cure unit to cure the coating. Next, a sanitary solvent-based coating is applied to the opposite side of the sheets. The sheets are then passed through a thermal oven used to cure the solvent-based coating. A typical cure profile for a solvent-based coating can be 204° C. for 10 minutes. The UV coating is exposed to the thermal process used to cure the solvent-based coating during can end manufacture. It is prudent to test UV coatings after exposing them to a thermal process when it is anticipated that the UV coatings will be exposed to a thermal process during the manufacturing process as described above.

Test Methods

All of the UV coatings of the invention and the comparative UV coatings are heated in an oven at 204° C. for 10 minutes after UV curing. After the thermal process, the coating samples are tested for flexibility and hardness and, where indicated, solvent resistance.

Flexibility

UV coating flexibility is determined using a retort wedge-bend method. TFS panels are bent and impacted perpendicular to the grain of the steel using a wedge-bend instrument in accordance with ATSM D3281-84. The bent panels are placed in the vapor phase of an autoclave and processed at 121° C. for one hour using deionized water. The length of the crack along the bend after processing is measured and recorded as the crack length. Coating flexibility is inversely related to the crack length.

Hardness

UV coating hardness is measured using a Konig pendulum hardness instrument. A pendulum is placed in contact with the coating surface and then set in motion. The amount of time (seconds) required to dampen the pendulum oscillation is measured by the instrument and is recorded as the coating hardness. Coating hardness is proportional to the time measured by the instrument.

Solvent Resistance

UV coating solvent resistance is measured by rubbing the coating with a cotton swab saturated with methyl ethyl ketone (MEK). The number of rubs using the swab required to dissolve the coating is recorded as the MEK resistance.

Surface-Cure Rate

Surface-cure rates are measured using a cotton ball method. The substrate used for the surface-cure rate experiments is aluminum foil laminated paper cards supplied by Leneta. Samples used to measure surface-cure rates are prepared by applying the UV coating to the substrate at a thickness of 4-5 microns using a number 2.5 wire-wound bar. The coating surface-cure rate is determined by passing a sample through the UV unit operated at given conveyor speed and then placing a cotton ball in contact with the coating surface immediately after the sample exits the UV cure chamber. The coating surface is judged to be cured if cotton fibers did not adhere to it. The conveyor speed is adjusted and the experiments are repeated until the maximum conveyor speed at which the sample is cured is determined. The maximum conveyor speed, in feet per minute (fpm), is recorded as the surface-cure rate.

Encapsulant Cracking

A paper ring is cut to the diameter of ¼-inch from laboratory filter paper. The paper ring is placed in the bottom of a laboratory aluminum-weighing dish. A steel washer (¼-inch diameter) is placed on top of the paper ring support. Anhydride-cure compositions are prepared by dissolving DABCO in cycloaliphatic epoxy resin at 70° C. TONE 0301 polyol and MHHPA are added to the epoxy resin and mixed thoroughly. Each tested epoxy/anhydride composition is poured over the steel washer. The samples are placed in an oven at 150° C. for four hours and then the oven is turned off and allowed to cool. After the oven has cooled to room temperature the samples are removed from the oven and visually examined to determine the extent of cracking in the encapsulant.

UV Coating Test Results

Tables 4-9 contain UV coating formulations and test results.

In Table 4, epoxy resins are blended 50/50 w/w with UVR-6110 and UV coating formulations are prepared using the blends. High concentrations of UVR-6110 typically make UV coatings harder but less flexible.

TABLE 4
Coating No.

| Ingredients | 1 | 2 | 3 | 4 | 5 | 6 | 7 | 8 | 9 | 10 | 11 | 12 | 13 |
|---|---|---|---|---|---|---|---|---|---|---|---|---|---|
| UVR-6110 | 48 | 48 | 48 | 48 | 48 | 48 | 48 | 48 | 48 | 48 | 48 | 48 | 48 |
| Resin O | 48 | | | | | | | | | | | | |
| Resin Q | | 48 | | | | | | | | | | | |
| UVR-6128 | | | 48 | | | | | | | | | | |
| Resin R | | | | 48 | | | | | | | | | |
| Resin F | | | | | 48 | | | | | | | | |
| Resin L | | | | | | 48 | | | | | | | |
| Resin P | | | | | | | 48 | | | | | | |
| Resin H | | | | | | | | 48 | | | | | |
| Resin G | | | | | | | | | 48 | | | | |
| Resin A | | | | | | | | | | 48 | | | |
| Resin D | | | | | | | | | | | 48 | | |
| Resin E | | | | | | | | | | | | 48 | |
| Resin S | | | | | | | | | | | | | 48 |
| UVI-6992 | 3.8 | 3.8 | 3.8 | 3.8 | 3.8 | 3.8 | 3.8 | 3.8 | 3.8 | 3.8 | 3.8 | 3.8 | 3.8 |
| L-7604 | 0.2 | 0.2 | 0.2 | 0.2 | 0.2 | 0.2 | 0.2 | 0.2 | 0.2 | 0.2 | 0.2 | 0.2 | 0.2 |
| Total | 100 | 100 | 100 | 100 | 100 | 100 | 100 | 100 | 100 | 100 | 100 | 100 | 100 |
| Retort wedge-bend crack | 51 | 44 | 43 | 42 | 41 | 41 | 39 | 37 | 35 | 34 | 33 | 27 | 21 |
| length (mm) | | | | | | | | | | | | | |
| Konig pendulum hardness (s) | 161 | 49 | 179 | 122 | 175 | 179 | 178 | 177 | 172 | 179 | 176 | 176 | 152 |
| MEK double rubs | 180 | 130 | 200 | 100 | 200 | 200 | 84 | 200 | 145 | 200 | 185 | 135 | 150 |
| Surface-cure rate (fpm) | * | * | 120 | * | 100 | 90 | 70 | 60 | 60 | 100 | 100 | 120 | 40 |

* Coating is not tack-free immediately after UV curing at 25 fpm. Coating becomes tack-free after post-bake (10 min at 400° F.) and it is then tested for physical properties.

Coatings of the invention are numbers 10-12. Comparative coatings are numbers 1-8 and 13. Coatings 10-12 have better flexibility than coatings 1-8, and coatings 10-12 are among the hardest coatings in Table 4. Coating 13 is more flexible but softer than coatings 10-12. Unexpectedly, Coatings 10-12 exhibit a superior combination of hardness, and low crack length (flexibility) versus the comparative materials.

In Table 5, epoxy resins are blended with TONE 0301 polyol. Typically, high concentrations of TONE polyol 0301 make coatings more flexible (and) softer.

TABLE 5
Coating No.

| Ingredients | 14 | 15 | 16 | 17 | 18 | 19 | 20 | 21 | 22 | 23 | 24 |
|---|---|---|---|---|---|---|---|---|---|---|---|
| Resin G | 83 | | | | | | | | | | |
| Resin O | | 86 | | | | | | | | | |
| Resin H | | | 81 | | | | | | | | |
| UVR-6110 | | | | 74 | | | | | | | |
| Resin P | | | | | 86 | | | | | | |
| UVR-6128 | | | | | | 80 | | | | | |
| Resin F | | | | | | | 79 | | | | |
| Resin L | | | | | | | | 79.75 | | | |
| Resin A | | | | | | | | | 81 | | |
| Resin A-Ti | | | | | | | | | | 81 | |
| Resin E | | | | | | | | | | | 79.8 |
| TONE 0301 | 12 | 9.3 | 14 | 22 | 9.8 | 16 | 17 | 15.75 | 15 | 15 | 15.8 |
| UVI-6992 | 4 | 4 | 4 | 4 | 4 | 4 | 4 | 4 | 4 | 4 | 4 |
| L-7604 | 0.5 | 0.5 | 0.5 | 0.5 | 0.5 | 0.5 | 0.5 | 0.5 | 0.5 | 0.5 | 0.5 |
| Total | 100 | 100 | 100 | 100 | 100 | 100 | 100 | 100 | 100 | 100 | 100 |
| R-value | 2.5 | 2.5 | 2.5 | 2.5 | 2.5 | 2.5 | 2.5 | 2.5 | 2.5 | 2.5 | 2.5 |
| Retort wedge-bend crack | 70 | 70 | 39 | 38 | 35 | 32 | 31 | 24 | 16 | 23 | 0** |
| length (mm) | | | | | | | | | | | |
| Konig pendulum hardness (s) | 140 | 100 | 160 | 190 | 35 | 138 | 140 | 75 | 187 | 182 | 190 |
| MEK double rubs | 45 | 60 | 50 | 200 | 32 | 35 | 30 | 60 | 50 | 100 | 90 |
| Surface-cure rate (fpm) | * | 25 | 25 | 70 | 25 | 50 | 35 | 30 | 35 | 25 | 25 |

* Coating is not tack-free after UV curing at 25 fpm. Coating becomes tack-free after post-bake (10 min at 400° F.) and is tested for physical properties.
**Coating has evidence of blisters. Adjustments to the formulation or the curing conditions can likely solve this problem, for example, by increasing the crosslink density.

Coatings of the invention are numbers 22-24. Comparative coatings are numbers 14-21. Coatings 22-24 were more flexible than coatings 14-21. Coatings 22-24 are also among the hardest in Table 5. The hardness of coating 17 is similar to coatings 22-24 but coating 17 is much less flexible.

In Table 6, coatings of the invention are numbers 32 and 33. Comparative coatings are numbers 25-31 and 34-36. Coatings 32 and 33 are the most flexible and the hardest coatings in Table 6. The flexibility of coating 34 is similar to coatings 32 and 33 but coating 34 is much softer. The hardness of coating 25 is similar to coatings 32 and 33 but coating 25 is much less flexible.

It is determined experimentally that Resin M, Resin A, and Resin C have epoxide equivalent weight values of 205, 206, and 207 g/epoxide equivalent, respectively. The small differences in epoxide equivalent weight values can not explain the large differences in performance among the three resins. Coating 31 is very soft. However, coating 31 does not resist retort well and the coating cracks more than coatings 32 and 33, which contain Resin A and Resin C, respectively, during retort after wedge bending. Unexpectedly, in spite of the improved hardness, coatings 32 and 33 have improved retort wedge bend properties compared to coating 31. The retort wedge bend test measures a combination of flexibility, adhesion, and resistance to high temperature water.

TABLE 6
Coating No.

| Ingredients | 25 | 26 | 27 | 28 | 29 | 30 | 31 | 32 | 33 | 34 | 35 | 36 |
|---|---|---|---|---|---|---|---|---|---|---|---|---|
| UVR-6110 | 70.2 | | | | | | | | | | | |
| D.E.R. 331 | | 75.4 | | | | | | | | | | |
| Resin I | | | 73.1 | | | | | | | | | |
| Resin J | | | | 73.7 | | | | | | | | |
| Resin K | | | | | 74.6 | | | | | | | |
| Resin F | | | | | | 76.0 | | | | | | |
| Resin M | | | | | | | 77.0 | | | | | |
| Resin A | | | | | | | | 77.0 | | | | |
| Resin C | | | | | | | | | 77.3 | | | |
| Resin N | | | | | | | | | | 78.2 | | |
| Resin G | | | | | | | | | | | 79.2 | |
| UVR-6128 | | | | | | | | | | | | 76.6 |
| TONE 0301 | 25.6 | 20.4 | 22.7 | 22.1 | 21.2 | 19.8 | 18.9 | 18.9 | 18.5 | 17.6 | 16.6 | 19.2 |
| UVI-6692 | 4 | 4 | 4 | 4 | 4 | 4 | 4 | 4 | 4 | 4 | 4 | 4 |
| DC-57 | 0.2 | 0.2 | 0.2 | 0.2 | 0.2 | 0.2 | 0.2 | 0.2 | 0.2 | 0.2 | 0.2 | 0.2 |
| Total | 100 | 100 | 100 | 100 | 100 | 100 | 100 | 100 | 100 | 100 | 100 | 100 |
| R-value | 2 | 2 | 2 | 2 | 2 | 2 | 2 | 2 | 2 | 2 | 2 | 2 |
| Retort wedge-bend | 37 | 38 | 28 | 24 | 24 | 24 | 22 | 15 | 16 | 17 | 100 | 27 |
| crack length (mm) | | | | | | | | | | | | |
| Konig pendulum | 187 | 177 | 158 | 152 | 129 | 124 | 49 | 189 | 191 | 51 | 88 | 134 |
| hardness (s) | | | | | | | | | | | | |
| Surface-cure rate (fpm) | 290 | 20 | 150 | 140 | 120 | 100 | 90 | 80 | 80 | 100 | 55 | 140 |

R-value = epoxide equivalents/hydroxyl equivalents;
s = seconds;
mm = millimeters;
fpm = feet per minute

The coatings in Table 7 are cured using different conveyor speeds, which result in different UV energy densities (dose) during cure. The coatings are also cured at different ambient relative humidity. The coatings are also heated to different temperatures before applying them to the TFS panels. These experiments are conducted to determine the effect of energy density or conveyor speed, ambient relative humidity during cure, and coating temperature during application on the coating flexibility.

A coating of the invention is number 40. Comparative coatings are numbers 37-39. Coating 40 is the most flexible coating in Table 7. In some cases the coatings appear to blister during retort but adjustments to the formulation or the curing conditions can likely solve this problem.

1,4-CHDM is used as a polyol in coating 38. Coating 40 contains Resin A, which contains a 1,4-CHDM residue in the epoxy resin backbone. Coating 38 is not as flexible as coating 40 under retort wedge-bend conditions. Thus, it is more advantageous to have a residue of 1,4-CHDM as part of the epoxy resin backbone.

TABLE 7
Coating No.

| Ingredients | 37 | 38 | 39 | 40 |
|---|---|---|---|---|
| UVR-6128 | 96 | 89.3 | | |
| UVR-6110 | | | 66 | |
| Resin A | | | | 90 |
| 1,4-CHDM | | 10.7 | | 10 |
| TONE 0305 | | | 30 | |
| UVI-6992 | 4 | 4 | 4 | 4 |
| L-7604 | 0.5 | 0.5 | 0.25 | 0.5 |
| Total | 100.5 | 104.5 | 100.25 | 104.5 |
| R-value | NA | 3 | 2.9 | 3 |

| | | Conveyor | Retort wedge-bend | | | |
|---|---|---|---|---|---|---|
| Relative | Coating | speed, | crack | | | |
| humidity | temperature, ° C. | fpm* | length, mm | | | |
| 32% | 75 | 25 | 41 | 37 | 39 | 15 |
| 32% | 75 | 100 | 38 | 36 | 35 | 11 |
| 32% | 75 | 400 | 37 | 30 | 41 | 1** |
| 32% | 25 | 25 | 42 | 37 | 37 | 16 |
| 32% | 25 | 100 | 37 | 33 | 37 | 9 |
| 32% | 25 | 400 | 39 | 23 | 29 | 2** |
| 69% | 25 | 25 | 36 | 36 | 34 | 5 |
| 69% | 25 | 100 | 36 | 29 | 19 | 6** |
| 69% | 25 | 400 | 29** | 17** | 5** | not |
| | | | | | | tested |

NA = not applicable because no polyol is used in the formulation.
*Conveyor speeds of 25, 100, and 400 fpm result in the coatings being exposed to energy densities of 600, 150, and 40 mJ/cm², respectively, while using a 300 W/in UV bulb.
**Coating appears to have blistered during retort.

The coatings in Table 8 contain only epoxy resin, cationic photoinitiator, and surfactant. No polyol is used in the coatings to provide flexibility. Coatings of the invention are numbers 42-44. A comparative coating is number 41.

UVR-6110 has an epoxide equivalent weight of about 137-g/epoxide equivalent. Coatings containing UVR-6110 and no polyol are hard and brittle because of the low epoxide equivalent weight of UVR-6110.

Resin A has an experimental epoxide equivalent weight value of about 207-g/epoxide equivalent. Distilled Resin A is a higher purity isomer of Resin A and it would be expected to have an epoxide equivalent weight value ranging from the theoretical epoxide equivalent weight value of about 196 to about 207-g/epoxide equivalent. Thus the epoxide equivalent weight values of Resin A, and Distilled Resin A are about 1.5 times higher than the epoxide equivalent weight value of UVR-6110.

Coatings 42-44 are much more flexible than coating 41 because of the higher epoxide equivalent weight values of epoxy resins Resin A and Distilled Resin A and the lower epoxide equivalent weight value of UVR-6110. The hardness values of coatings 42, 43, and 44 are similar to coating 41.

TABLE 8
Coating No.

| Ingredients | 41 | 42 | 43 | 44 |
|---|---|---|---|---|
| UVR-6110 | 95.5 | | | |
| Resin A | | 95.5 | | |
| Distilled Resin A | | | 95.5 | |
| Resin B | | | | 95.5 |
| UVI-6992 | 4 | 4 | 4 | 4 |
| L-7604 | 0.5 | 0.5 | 0.5 | 0.5 |
| Total | 100 | 100 | 100 | 100 |
| Retort wedge-bend crack length (mm) | 68 | 19 | 26 | 31 |
| Konig pendulum hardness (s) | 182 | 174 | 174 | 180 |
| Surface-cure rate* (fpm) | not tested | 62 | 80 | 92 |

*The ambient relative humidity ranges from 71% to 76%.

Coatings of the invention are numbers 47-49. Comparative coatings are numbers 45 and 46. Coatings 47-49 are more flexible and harder than coating 46. Coatings 4749 are more flexible but softer than coating 45.

TABLE 9
Coating No.

| Ingredients | 45 | 46 | 47 | 48 | 49 |
|---|---|---|---|---|---|
| UVR-6110 | 70 | | | | |
| UVR-6128 | | 76.5 | | | |
| Resin A | | | 76.5 | | |
| Distilled Resin A | | | | 76.5 | |
| Resin B | | | | | 76.5 |
| TONE 0301 | 25.5 | 19 | 19 | 19 | 19 |
| UVI-6992 | 4 | 4 | 4 | 4 | 4 |
| L-7604 | 0.5 | 0.5 | 0.5 | 0.5 | 0.5 |
| Total | 100 | 100 | 100 | 100 | 100 |
| R-value | 2 | 2 | 2 | 2 | 2 |
| Retort wedge-bend crack length (mm) | 40 | 30 | 15 | 16 | 17 |
| Konig pendulum hardness (s) | 180 | 100 | 118 | 128 | 164 |
| Surface-cure rate (fpm) | 50 | 40 | 25 | 35 | 70 |

Test Results of Anhydride-Cured Compositions

Anhydride-cure compositions in Table 10 are tested in the washer thermal cycle test (Encapsulant Cracking) as described above. Composition number 50 is a composition of the invention. Composition number 51 is a comparative composition. Composition 50 has fewer cracks than composition 51 near the steel washer after the thermal cycle indicating that composition 50 is tougher than composition 51.

TABLE 10
Anhydride-cure compositions

| Ingredients | 50 | 51 |
|---|---|---|
| distilled Resin A | 24.95 | |
| ERL-4221D | | 19.67 |
| MHHPA | 17.27 | 21.96 |
| TONE 0301 | 2.56 | 3.26 |
| DABCO | 0.26 | 0.33 |
| Total | 45.04 | 45.22 |

What is claimed is:

1. A method of enhancing the toughness of a coating on an article, said coating comprising a cured cycloaliphatic epoxy resin, said method comprising (a) applying a photocurable composition on said article; and (b) curing the photocurable composition; wherein the photocurable composition comprises an effective amount of a photoinitiator, and an epoxy resin compound of the following formula: 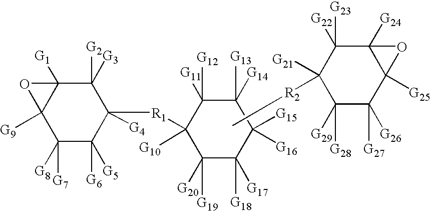
wherein R₁ and R₂ are divalent organic moieties that may be the same or different; and wherein G₁ through G₂₉ is hydrogen; phenyl; or substituted or unsubstituted alkyl or alkene groups having from 1 to about 10 carbon atoms.

2. The method of claim 1 wherein the cycloaliphatic epoxy resin comprises the reaction product of from about 40 to about 95 weight percent of a cycloaliphatic epoxide carboxylic acid ester and from about 5 to about 60 weight percent of the hydroxy functional compound.

3. The method of claim 1 wherein R₁ is

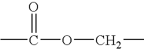

4. The method of claim 1 wherein R₁ is

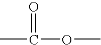

5. The method of claim 1 wherein R₁ and R₂ are each

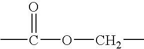

6. The method of claim 1 wherein each of G₁₋₂₉ are hydrogen.

7. A photocurable composition comprising an effective amount of a photoinitiator, and an epoxy resin of the following formula: 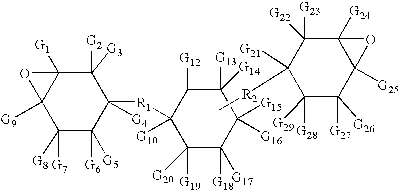
wherein R₁ and R₂ are divalent organic moieties that may be the same or different; and wherein G₁ through G₂₉ is hydrogen; phenyl; or substituted or unsubstituted alkyl or alkene groups having from 1 to about 10 carbon atoms.

8. A thermally-curable LED encapsulant formulation composition comprising an effective amount of a thermally-activated initiator, and an epoxy resin of the following formula: 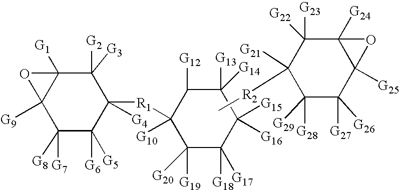
wherein R₁ and R₂ are divalent organic moieties that may be the same or different; and wherein G₁ through G₂₉ is hydrogen; phenyl; or substituted or unsubstituted alkyl or alkene groups having from 1 to about 10 carbon atoms.
